(19) United States
(12) Patent Application Publication
(10) Pub. No.: US 2022/0378015 A1
(43) Pub. Date: Dec. 1, 2022

(54) FERAL HOG FEEDER ASSEMBLY

(71) Applicant: WPF Inc., Palmetto, FL (US)

(72) Inventor: Johnny E. Wammock, St. Petersburg, FL (US)

(21) Appl. No.: 17/333,551

(22) Filed: May 28, 2021

(51) Int. Cl. A01K 5/02; A01K 5/01

(52) U.S. Cl. CPC A01K 5/025; A01K 5/0114; A01K 5/0233

(57) ABSTRACT

Feral hog feeding assemblies and devices configured to selectively meter predetermined amounts of food, toxin, birth control/sterilizing agents or any combination thereof and track and communicate the same to a peripheral device to track frequency of use thereof while concurrently reducing and/or minimizing entry of non-feral hog animals.

### TECHNICAL FIELD

The present invention relates generally to the field of animal feeding devices, and more particularly, to feral hog feeding devices configured to meter predetermined amounts of food, toxin, birth control/sterilizing agents or combinations thereof upon entry into the device and to further track and communicate the same to a user's peripheral device to remotely monitor frequency of use thereof while concurrently reducing and/or minimizing entry of non-feral hog animals.

### BACKGROUND

Feral hogs are an invasive pest species that frequently invade wooded areas as well as farm land and subsequently wreak havoc thereon often irreparably damaging these invaded areas due to their ravenous appetites, high breeding rates, and general destructive nature. Furthermore, due to the high breeding rates as well as aggressive nature, feral hog populations are difficult to control and/or eliminate once feral hog infestation and/or invasion into a particular area has occurred. Moreover, due to the highly aggressive nature of feral hogs, active eradication of this invasive species, for example, through hunting often proves to be a dangerous activity.

U.S. Pat. No. 10,034,454 sought to provide a feeding device that addressed many of the problems mentioned above. However, several problems remained. In particular, dispensing birth control agents and toxin proved difficult as these substances were pre-mixed with the food supply, maintained in the bulk food bin, and subsequently dispensed accordingly from that feeding device. However, unless feral hogs were frequently eating from that device, potency and efficacy of the toxin and/or birth control agent quickly diminished due to the pre-mixed nature of the food and these components. Moreover, the above-mentioned device was not equipped with a convenient means to monitor overall use and food supply within the device, which led to frequent and unnecessary in-person monitoring of the food levels in this device, which also proved problematic and inconvenient for that device user as well as a potential deterrent for the feral hogs.

### SUMMARY

In view of the above mentioned problems, disclosed herein are feral hog assemblies and feral hog feeders that are equipped to monitor usage of these assemblies and feeders and to transmit such data to a peripheral device in a location remote to the assemblies and feeders. The above mentioned feature(s) advantageously allows a user to remotely monitor and track usage frequency of the feeder and feeder assemblies as well as remaining amounts of food, toxin, and birth control agents, which allows the user to efficiently determine when to refill food, toxin, and/or birth control agents therein as well as whether the feeders/assemblies should maintain their positioning or be moved to another location. Moreover, within the disclosed feral hog assemblies and feeders, the food remains separated and is separately dispensed from, for example, the toxin and/or birth control agent. The assemblies and feeders are advantageously configured to immediately dispense the toxin and/or birth control agent immediately before feral hog entry into an enclosed housing thereby maintaining freshness, potency, and efficacy of the toxin and birth control agent for significantly longer time periods than other known devices. Moreover, the devices disclosed herein have several features that selectively deter animals that are not feral hogs. These features include, but are not limited to, spaced apart bars (roll bars) within the partially enclosed ramp and a weight activated floor having a predetermined weight threshold as well as sidewalls form part of the partially enclosed ramp. In certain aspects, disclosed herein is a feral hog feeder assembly including (a) a partially enclosed entrance ramp configured for entry of feral hogs therein while concurrently deterring entry of non-porcine animals; (b) an enclosed housing directly attached to one end of the partially enclosed entrance ramp, the enclosed housing having an openable and closable door positioned adjacent to the one end of the partially enclosed entrance ramp and a food dispensing device as well as a birth control dispensing device and/or toxin dispensing device housed within the enclosed housing, the food dispensing device as well as the birth control dispensing device and/or toxin dispensing device are configured to dispense predetermined amounts of food, birth control agents, and toxin; and (c) a global positioning system (GPS) unit operably coupled to the door, the GPS unit is configured to monitor frequency of use of the assembly by feral hogs by tracking and transmitting frequency of door openings and closings to a peripheral device of a user.

In certain aspects, the GPS unit of the assembly is further configured to track amounts of food remaining in the feeder/assembly (bulk food storage trough), amount of birth control agents remaining in the birth control dispensing device, amount of toxin remaining in the toxin dispensing device, or any combination thereof based on the frequency of door openings and closings.

In certain aspects, the partially enclosed ramp of the assembly includes: (i) an opening on one end of the partially enclosed ramp that is spaced apart from and opposite to the end directly attached to the enclosed housing; (ii) two spaced apart sidewalls spanning an entire length between the opening of the partially enclosed ramp and the end directly attached to the enclosed housing, the two spaced apart sidewalls configured to maintain the feral hogs therein; and (iii) a bottom wall positioned between and directly connected to the two spaced apart sidewalls.

In certain aspects, the partially enclosed ramp of the assembly further comprises a weight activated floor attached thereto that is spaced apart and positioned above the bottom wall of the partially enclosed ramp, the weight activated floor is configured to move from an elevated first position in a direction towards the bottom wall when a predetermined weight threshold is applied thereon to allow for opening of the door.

In certain aspects, the weight activated floor of the assembly extends internally within the enclosed housing and underneath the openable and closable door, the weight activated floor including a door stop positioned thereon that prevents opening of the door internally into the enclosed housing until the predetermined weight threshold is applied on the weight activated floor and the weight activated floor is moved in a direction towards the bottom wall of the partially enclosed ramp.

In certain aspects, the food dispensing device of the assembly comprises a feed trough and a bulk food storage trough that are in fluid communication with one another when the weight activated floor is in the elevated first position and the feed trough and bulk food storage trough are selectively separated from one another by a partition positioned on an end of the weight activated floor is moved in a direction towards the bottom wall of the partially enclosed ramp.

In certain aspects, the birth control dispensing device of the assembly and/or toxin dispensing device of the assembly is positioned above the feed trough and configured to dispense the birth control agent and/or toxin into the feed trough as the weight activated floor is moved in a direction towards the bottom wall of the partially enclosed ramp.

In certain aspects, the weight activated floor of the assembly and birth control dispensing device of the assembly and/or toxin dispensing device of the assembly are operably connected to one another and move in concert with one another.

In certain aspects, the assembly further includes a biasing member operably connected to the partition positioned on the end of the weight activated floor and the birth control dispensing device and/or toxin dispensing device and configured: (i) to bias the birth control dispensing device and/or toxin dispensing device in a closed, non-dispensing position while the weight activated floor is in the elevated first position; and (ii) to selectively move the birth control dispensing device and/or toxin dispensing device into an open, dispensing position when the weight activated floor is actuated in a direction towards the bottom wall of the partially enclosed ramp such that birth control agents and/or toxin is dispensed from the respective birth control dispensing and/or toxin dispensing devices when the partition positioned on the end of the weight activated floor separates the feed trough from the bulk food storage trough.

In certain aspects, the birth control dispensing device of the assembly and/or toxin dispensing device of the assembly includes a plurality of plates in which: (i) a first plate is fixed in place and is configured to receive an opened container of birth control agents, toxins or a combination thereof thereon; (ii) an actuatable plate positioned immediately underneath the first plate that is operably connected to the biasing member, the actuatable plate is configured to move from a closed position in which the actuatable plate includes an opening configured to align with an opening formed in the first plate to receive a predetermined amount of birth control agents, toxins, and/or a combination thereof therein to an open position in which the actuatable plate moves toward an opening positioned immediately beneath the actuatable plate (that is axially aligned with the feed trough immediately below) such that the opening in the actuatable plate having the predetermined amount of birth control agents, toxins, and/or a combination thereof therein aligns with openings positioned immediately beneath the actuatable plate to dispense the birth control agents, toxins or a combination thereof from the actuatable plate into the feed trough.

In certain aspects, the feed assembly further includes a plurality of spaced apart bars securely positioned above the weight activated floor that are configured to deter non-ungulate animals from entering the partially enclosed ramp, each bar having a longitudinal axis that is perpendicular relative to a longitudinal axis of the partially enclosed ramp. Each bar of the assembly is rotatable about its longitudinal axis.

In certain aspects, the assembly further includes stabilization bars affixed to the assembly that are configured to stabilize and reduce and/or prevent the assembly from flipping over when assembled.

In certain aspects, a first stabilization bar of the assembly is affixed to a bottom surface of the partially enclosed entrance ramp and extends in a direction away from an outermost surface of each of the two spaced apart sidewalls, and a second stabilization bar of the assembly is affixed to a bottom surface of the enclosed housing and extends in a direction from outermost surfaces of the enclosed housing, with the first and second stabilization bars being arranged parallel to one another.

In certain aspects, the toxin comprises a lethal amount of sodium nitrite and optionally a masking agent and the birth control agent comprises an effective amount of cotton seed oil and/or gossypol.

In further aspects, also disclosed herein is a feral hog feeder including: (a) a partially enclosed entrance ramp configured for entry of feral hogs therein while concurrently deterring entry of non-porcine animals; (b) an enclosed housing directly attached to one end of the partially enclosed entrance ramp, the enclosed housing having an openable and closable door positioned adjacent to the one end of the partially enclosed entrance ramp and a food dispensing device as well as a birth control dispensing device and/or toxin dispensing device housed within the enclosed housing, the food dispensing device as well as the birth control dispensing device and/or toxin dispensing device are configured to dispense predetermined amounts of food, birth control agents, and toxin; and (c) a global positioning system (GPS) unit operably coupled to the door, the GPS unit is configured to monitor frequency of use of the feeder by feral hogs by tracking and transmitting frequency of door openings and closings to a peripheral device of a user.

In certain aspects, the GPS unit of the feeder is further configured to track amounts of food remaining in the feeder/assembly (bulk food storage trough, amount of birth control agents remaining in the birth control dispensing device, amount of toxin remaining in the toxin dispensing device, or any combination thereof based on the frequency of door openings and closings.

In certain aspects, the partially enclosed ramp of the feeder includes (i) an opening on one end of the partially enclosed ramp that is spaced apart from and opposite to the end directly attached to the enclosed housing; (ii) two spaced apart sidewalls spanning an entire length of the ramp between the opening of the partially enclosed ramp and the end directly attached to the enclosed housing, the two spaced apart sidewalls configured to maintain the feral hogs therein; and (iii) a bottom wall positioned between and directly connected to the two spaced apart sidewalls.

In certain aspects, the partially enclosed ramp of the feeder further comprises a weight activated floor attached thereto that is spaced apart and positioned above the bottom wall of the partially enclosed ramp, the weight activated floor is configured to move from an elevated first position in a direction towards the bottom wall when a predetermined weight threshold is applied thereon to allow for opening of the door.

In certain aspects, the weight activated floor of the feeder extends internally within the enclosed housing and underneath the openable and closable door, the weight activated floor including a door stop positioned thereon that prevents opening of the door internally into the enclosed housing until the predetermined weight threshold is applied on the weight activated floor and the weight activated floor is moved in a direction towards the bottom wall of the partially enclosed ramp.

In certain aspects, the food dispensing device of the feeder comprises a feed trough and a bulk food storage trough of the feeder that are in fluid communication with one another when the weight activated floor is in the elevated first position and the feed trough and bulk food storage trough are selectively separated from one another by a partition positioned on an end of the weight activated floor is moved in a direction towards the bottom wall of the partially enclosed ramp.

In certain aspects, the birth control dispensing device of the feeder and/or toxin dispensing device of the feeder is positioned above the feed trough and configured to dispense the birth control agent and/or toxin into the feed trough as the weight activated floor is moved in a direction towards the bottom wall of the partially enclosed ramp.

In certain aspects, the weight activated floor of the feeder and birth control dispensing device of the feeder and/or toxin dispensing device of the feeder are operably connected to one another and move in concert with one another.

In certain aspects, the feeder further includes a biasing member operably connected to the partition positioned on the end of the weight activated floor and the birth control dispensing device and/or toxin dispensing device and configured: (i) to bias the birth control dispensing device and/or toxin dispensing device in a closed, non-dispensing position while the weight activated floor is in the elevated first position; and (ii) to selectively move the birth control dispensing device and/or toxin dispensing device into an open, dispensing position when the weight activated floor is actuated in a direction towards the bottom wall of the partially enclosed ramp such that birth control agents and/or toxin is dispensed from the respective birth control dispensing and/or toxin dispensing devices when the partition positioned on the end of the weight activated floor separates the feed trough from the bulk food storage trough.

In certain aspects, the birth control dispensing device of the feeder and/or toxin dispensing device of the feeder comprises a plurality of plates in which: (i) a first plate is fixed in place and is configured to receive an opened container of birth control agents, toxins or a combination thereof thereon; (ii) an actuatable plate positioned immediately underneath the first plate that is operably connected to the biasing member, the actuatable plate is configured to move from a closed position in which the actuatable plate includes an opening configured to align with an opening formed in the first plate to receive a predetermined amount of birth control agents, toxins, and/or a combination thereof therein to an open position in which the actuatable plate moves toward an opening positioned immediately beneath the actuatable plate such that the opening in the actuatable plate (that is axially aligned with the feed trough immediately below) having the predetermined amount of birth control agents, toxins, and/or a combination thereof therein aligns with openings positioned immediately beneath the actuatable plate to dispense the birth control agents, toxins or a combination thereof from the actuatable plate into the feed trough.

In certain aspects, the feeder further includes a plurality of spaced apart bars securely positioned above the weight activated floor that are configured to deter non-ungulate animals from entering the partially enclosed ramp, each bar having a longitudinal axis that is perpendicular relative to a longitudinal axis of the partially enclosed ramp. Each bar of the feeder is rotatable about its longitudinal axis to direct contact towards the weight activated floor.

In certain aspects, the feeder further includes stabilization bars affixed to the feeder that are configured to stabilize and reduce and/or prevent the feeder from flipping over when in use.

In certain aspects, a first stabilization bar is affixed to a bottom surface of the partially enclosed entrance ramp and extends in a direction away from an outermost surface of each of the two spaced apart sidewalls, and a second stabilization bar is affixed to a bottom surface of the enclosed housing and extends in a direction from outermost surfaces of the enclosed housing, with the first and second stabilization bars being arranged parallel to one another.

In certain aspects, the toxin comprises a lethal amount of sodium nitrite and optionally a masking agent and the birth control agent comprises an effective amount of cotton seed oil and/or gossypol.

In certain aspects, also disclosed are trailers and/or dollies configured to transport the disclosed assemblies and feeders from one location to another.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is a perspective view of the feral hog feeder;

FIG. 2 is the perspective view of the feral hog feeder of FIG. 1 with a sidewall removed;

FIG. 3 is a back perspective view of the feral hog feeder of FIG. 2;

FIG. 4 is side view of the feral hog feeder with a sidewall removed with the weight activated floor in an elevated first position and the door in a closed position;

FIG. 5 is a side view of the feral hog feeder with a sidewall removed with the weight activated floor in a lowered position in which the door may be opened into the enclosed housing;

FIG. 6 is a top view of the feral hog feeder;

FIG. 7 is a front view of the feral hog feeder;

FIG. 8 is an exploded view of the birth control dispensing device and/or toxin dispensing device;

FIG. 9 depicts the partially assembled birth control dispensing device and/or toxin dispensing device;

FIG. 10 depicts the assembled view birth control dispensing device and/or toxin dispensing device;

FIG. 11 is a cross-section of the feral hog feeder in use with the weight activated floor in an elevated first position such that the feed trough and bulk food storage trough that are in fluid communication with one another such that feed can be metered from the bulk food storage trough into the feed trough, with the door in a closed position, and with the birth control dispensing device and/or toxin dispensing device in a non-dispensing position; and

FIG. 12 is a cross-section of the feral hog feeder in use with the weight activated floor in a lowered position such that the feed trough and the bulk food storage trough that are separated by the partition positioned on an end of the weight activated floor such that feed cannot be metered from the bulk food storage trough into the feed trough, with the door in an open position, and with the birth control dispensing device and/or toxin dispensing device in a dispensing position actively dispensing birth control agent and/or toxin therefrom.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

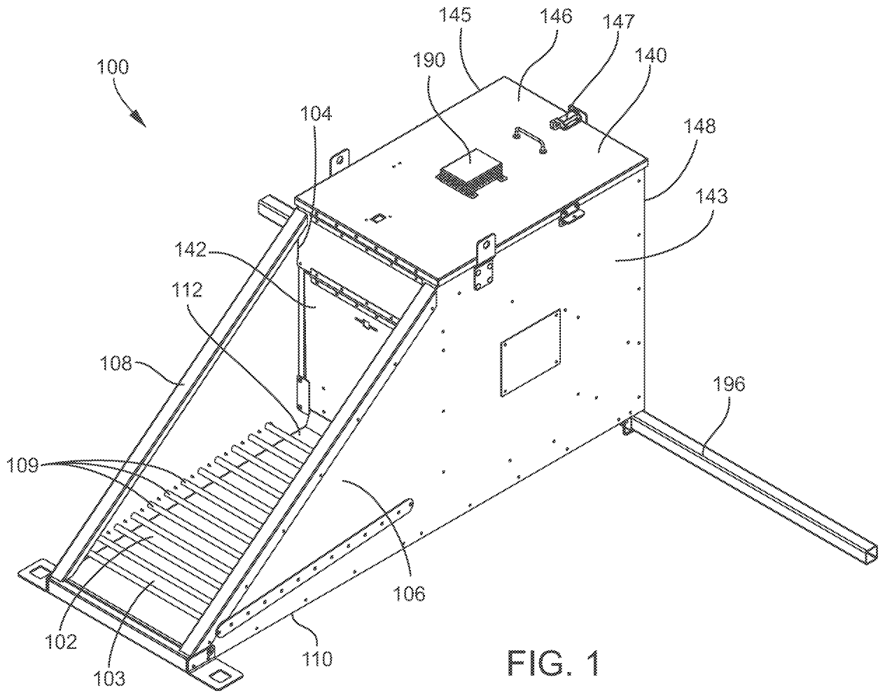

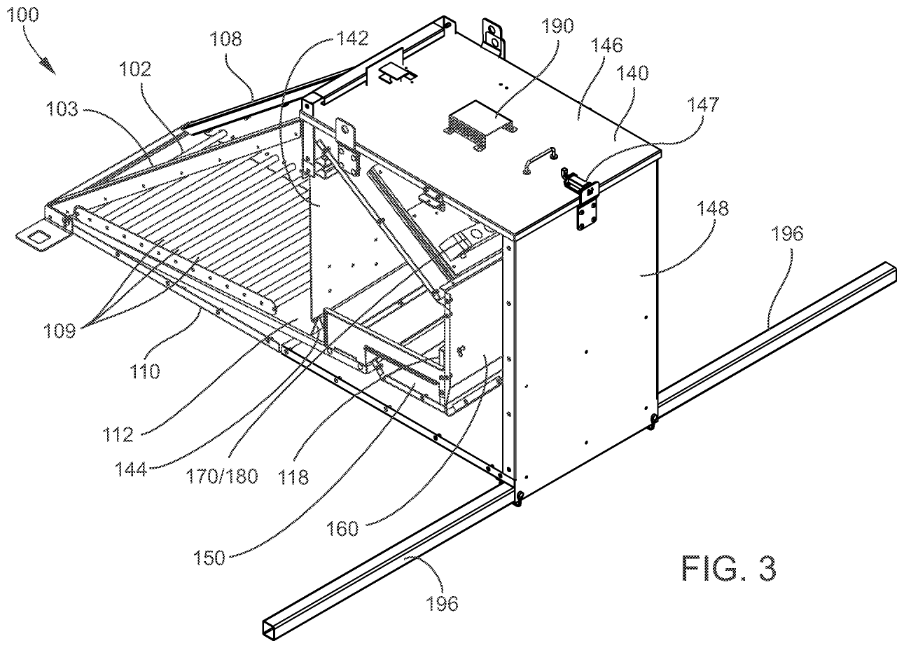

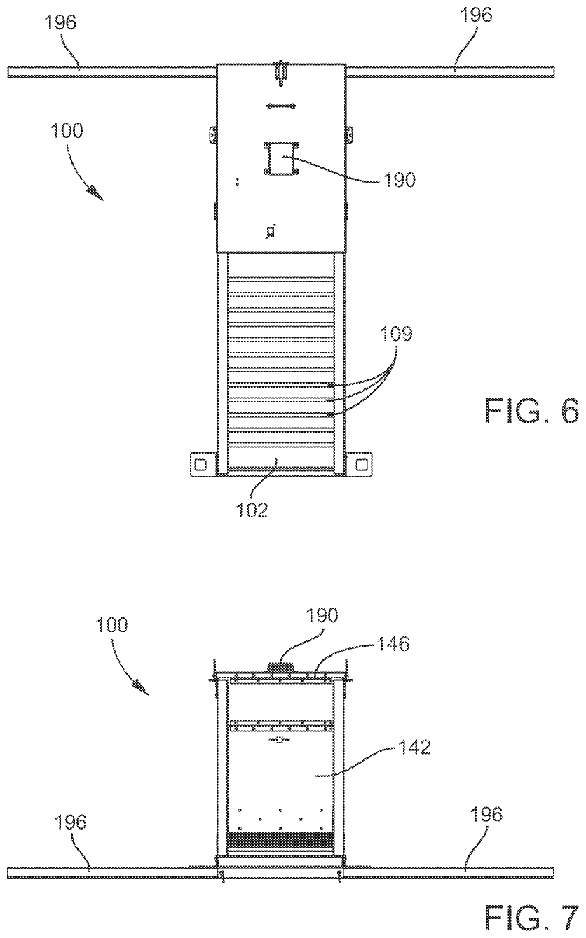

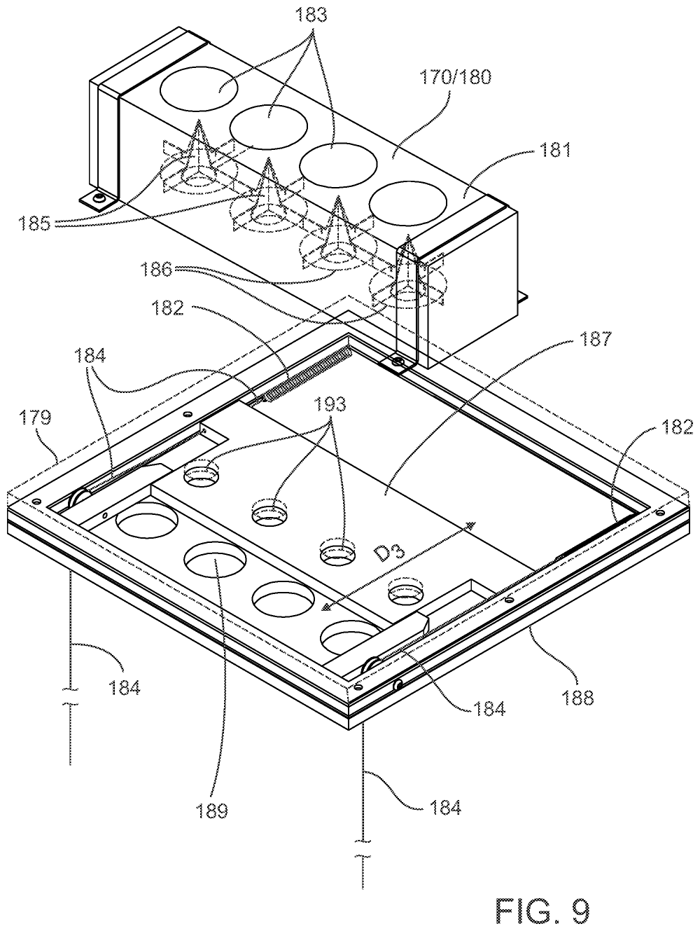

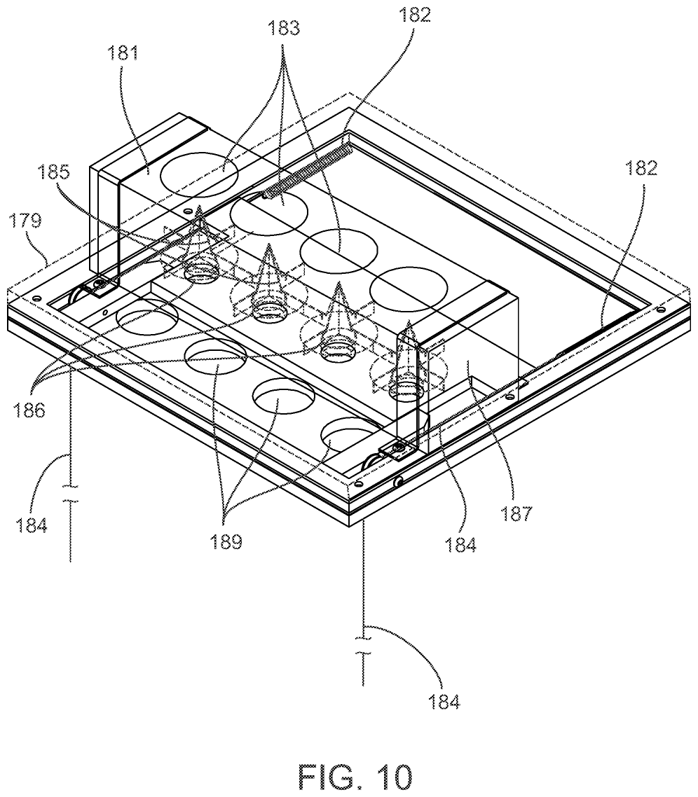

As shown in FIGS. 1-12, disclosed herein are feral hog feeders and feral hog feeder assemblies (collectively (100)) that can selectively meter predetermined amounts of food as well as selectively dispense upon entry into the enclosed housing (140) toxin and/or birth control agents ((270), (280)) from a birth control and/or toxin dispensing device (170, 180). The feeders and assemblies (100) are further advantageously equipped to monitor usage of these assemblies and/or feeders and to transmit such data to a peripheral device in a location remote to the assemblies and feeders, which advantageously allows a user to remotely monitor and track usage frequency of the feeder and feeder assemblies as well as remaining amounts of food, toxin, and birth control agents, which allows the user to efficiently determine when to refill food, toxin, and/or birth control agents therein as well as whether the assemblies should maintain their positioning or be moved to another location.

Particularly shown in FIGS. 1-7, 11, and 12 are feral hog feeders and feral hog feeder assemblies (100) including (a) a partially enclosed entrance ramp (102) configured for entry of feral hogs therein while concurrently deterring entry of non-porcine animals; (b) an enclosed housing (140) directly attached to one end (104) of the partially enclosed entrance ramp (102), the enclosed housing having an openable and closable door (142) positioned adjacent to the one end (104) of the partially enclosed entrance ramp (102) and a food dispensing device (160) as well as a birth control dispensing device (170) and/or toxin dispensing device (180) housed within the enclosed housing, the food dispensing device as well as the birth control dispensing device and/or toxin dispensing device are configured to dispense predetermined amounts of food, birth control agents, toxin or combinations thereof; and (c) a global positioning system (GPS) (190) unit operably coupled to the door, the GPS unit is configured to monitor frequency of use of the assembly by feral hogs by tracking and transmitting frequency of door openings and closings to a peripheral device of a user. The GPS unit (190) is further configured to track amounts of food remaining in the bulk food storage trough (160), amounts of birth control agents remaining in the birth control dispensing device (170), amounts of toxin remaining in the toxin dispensing device (180), or any combination thereof based on the frequency of door (142) openings and closings and transmit the same to the peripheral device of the user.

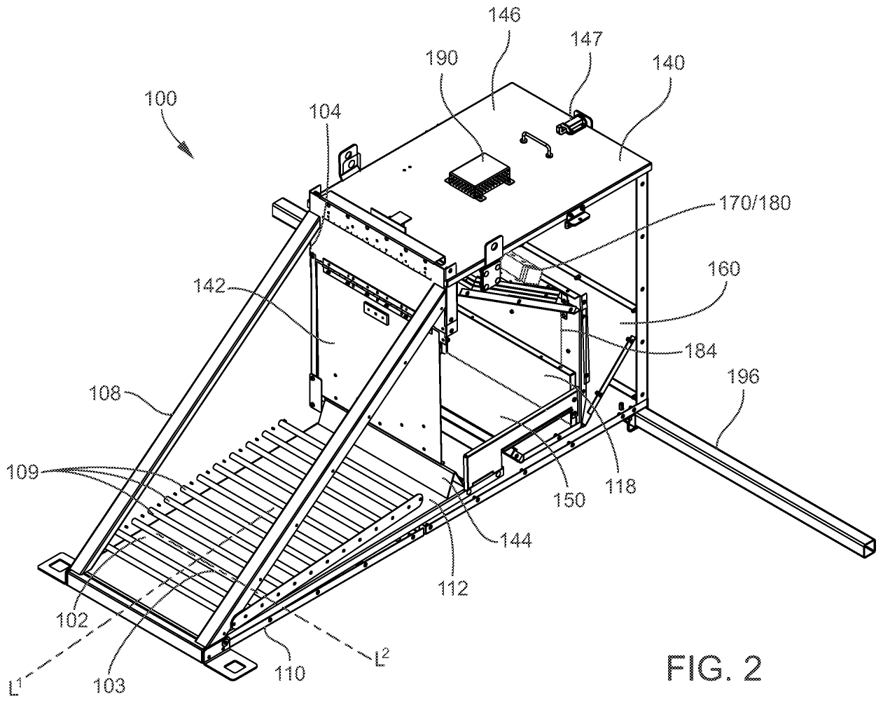

As shown in FIGS. 1-3, the partially enclosed ramp (102) includes: (i) an opening (103) on one end of the feeder/assembly (100) that is spaced apart from and opposite to the end (104) directly attached to the enclosed housing (140); (ii) two spaced apart sidewalls (106, 108) spanning an entire length between the opening (103) of the partially enclosed ramp and the end (104) directly attached to the enclosed housing, the two spaced apart sidewalls configured to maintain the feral hogs therein; and (iii) a bottom wall (110) positioned between and directly connected to the two spaced apart sidewalls (106, 108). As further shown in FIGS. 2-5, 11, and 12, the partially enclosed ramp (102) further includes a weight activated floor (112) attached thereto (i.e., pivotally attached via a hinge positioned at the opening (103)) that is spaced apart and positioned above the bottom wall (110) of the partially enclosed ramp (102). The weight activated floor (112) is configured to move from an elevated first position in a direction towards the bottom wall (110) (i.e., into a lowered position) when a predetermined weight threshold is applied thereon, which further allows for opening of the door (142). As further shown in FIGS. 1-5, the partially enclosed ramp further includes a plurality of spaced apart bars (109) securely positioned above the weight activated floor that are advantageously configured to deter non-ungulate animals (i.e., non-hoofed animals) from entering the partially enclosed ramp, and more particularly deterring animals that are not feral hogs failing to meet the predetermined weight threshold from entering the partially enclosed ramp (102). In certain preferred aspects, each bar of the plurality of spaced apart bars (109) has a longitudinal axis (L²) that is perpendicular relative to a longitudinal axis (L¹) of the partially enclosed ramp (102), and each bar is rotatable about its longitudinal axis (L²) such that the bar rotation is perpendicular to the longitudinal axis (L¹) of the partially enclosed ramp (102); rotation of the bars directs hooves onto and ensures contact with the weight activated floor.

The above mentioned sidewalls (106, 108), weight activated floor (112), and plurality of spaced apart bars (109) of the partially enclosed ramp are each configured to advantageously deter animals that are not feral hogs and/or feral hogs not meeting the desired weight threshold. For example, the predetermined weight threshold (i.e., the threshold to move/actuate the biasing member described below) of the weight activated floor (112) is at least 60 pounds, 70 pounds, 80 pounds, 90 pounds, or 100 pounds in order to activate and deploy the weight activated floor from an elevated first position to a lowered position such that the door (142) may be opened. The above mentioned weight threshold advantageously ensures that smaller animals such as skunks, opossums, raccoons, rabbits, deer, and/or feral hogs failing to meet the weight threshold cannot deploy the weight activated ramp and gain entry into the enclosed housing to consume the food, birth control agent, and/or toxin dispensed therein. Moreover, the spacing (e.g., periodic and/or uniform spacing) and/or rotation of the spaced bars (109) further serves as a deterrent to certain larger animals (e.g., bears). For example, it is well known that ungulates such as feral hogs, cows, and deer are not deterred by bars and/or rotating bars (roll bars) such as those disclosed herein while animals with paws such as bears are easily deterred and will not walk on surfaces having spacing and/or rotation as disclosed immediately above. Furthermore, while deer, in theory, would not be deterred by the above mentioned spaced apart bars (109) including the spacing and rotation disclosed above, deer are generally a “line of sight” animal that quickly flee an area if their line of sight becomes unexpectedly occluded. As shown in FIGS. 1-3, the spaced apart sidewalls (106, 108) constantly increase in height (and slope) when approaching the openable and closable door (142) of the enclosed housing (140). When attempting to open the door (142), the deer's lateral line of sight would be completely (and unexpectedly) occluded by the spaced apart sidewall (106, 108) and door (142) arrangement, which further advantageously serves as a deterrent leading to deer exiting the feeder/assembly (100) before entering the enclosed housing (140) and/or consuming the food (260) therein.

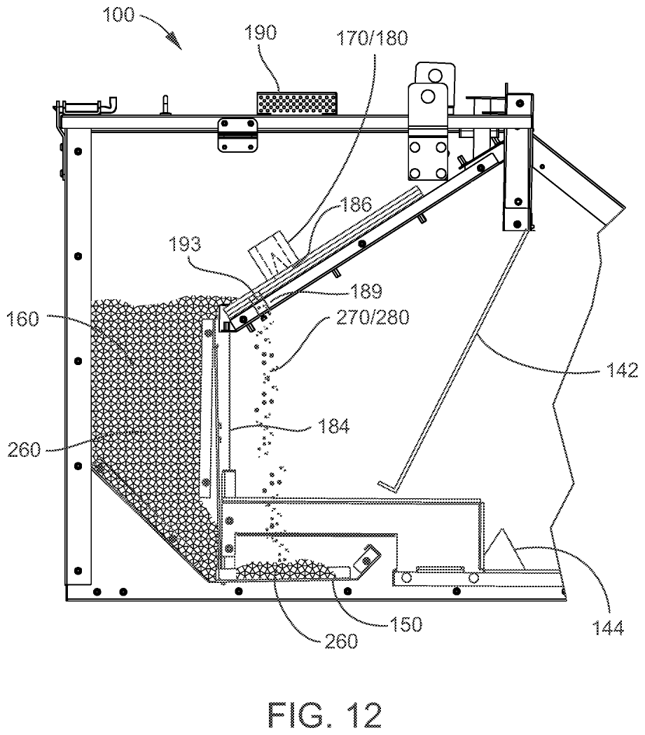

FIG. 1 further depicts the external features/components of the enclosed housing (140) As shown in FIG. 1, the enclosed housing (140) includes an openable and closable door (142) a plurality of sidewalls (143, 145, 148), and lid (146) that comprise the external features of the enclosed housing. As shown in FIGS. 1 and 12, the door (142) is pivotally connected (e.g., via a hinge) to the enclosed housing (140) and is configured to open when door stop (144) does not block rotation of the door internally into the enclosed housing. Likewise, the lid (146) is pivotally connected (e.g., via a hinge) to one of the plurality of sidewalls (143, 145, 148) of the enclosed housing such that the lid is configured for opening and closing so that a user may access the internal components of the enclosed housing and may refill food (260) within the bulk food storage trough (160), toxin, birth control agent, or any combination thereof as desired. The lid (146) also has a securing mechanism (147) (e.g., a lock) positioned thereon to securely fasten the lid while the feeder/assembly is in use to prevent access within the top of the feeder/assembly while in use. Also, the GPS unit (190) is positioned on the lid and operably connected to the door (142) to remotely monitor feral hog entry, food levels, toxin amount, birth control amount, or a combination thereof by a feeder/assembly user.

FIGS. 2-4, 11, and 12 depict the internal components of the feeder/assembly (100) positioned within the enclosed housing (140). In particular and as shown in FIGS. 2-4, 11, and 12, the internal components of the feeder/assembly positioned within the enclosed housing (140) include a portion of the weight activated floor (112) having the door stop (144) and partition (118) positioned thereon, the feed trough (150), the bulk food storage trough (160), and the birth control dispensing device (170) and/or toxin dispensing device (180) positioned above the feed trough (150). As discussed further below, the weight activated floor (112), partition (118), and birth control dispensing device (170) and/or toxin dispensing device (180) are operably connected to one another to dispense food, birth control agent, and/or toxin depending on the positioning of the weight activated floor (i.e., in either in the elevated first position or the lowered position).

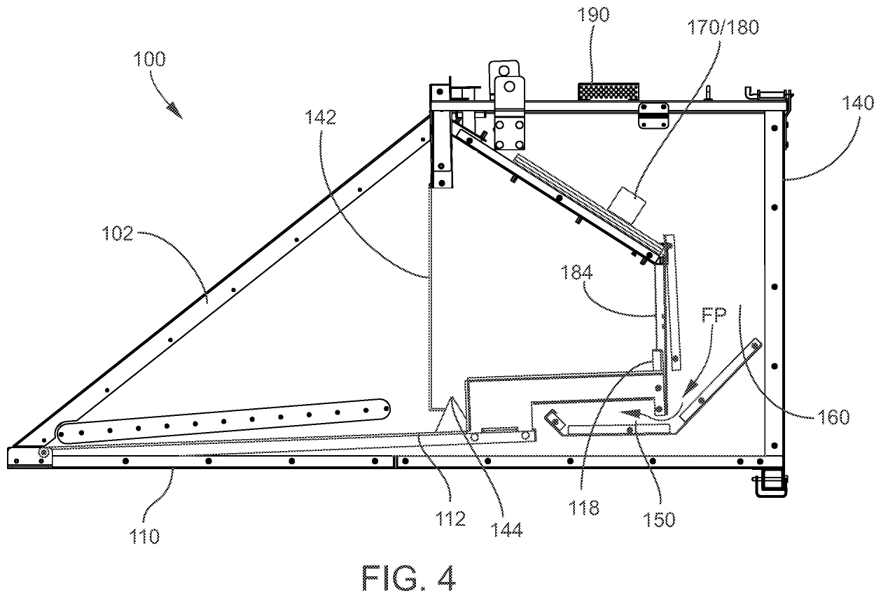

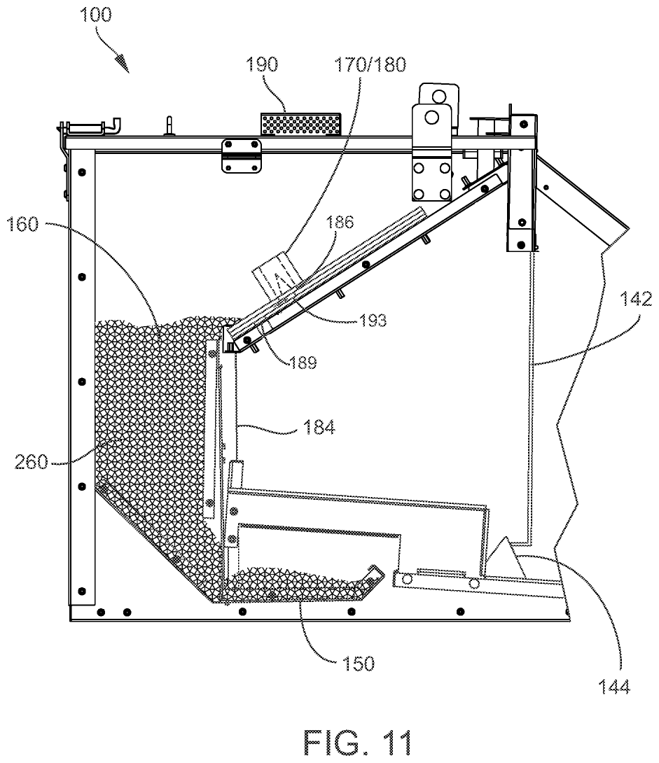

FIGS. 4 and 11 depict the feral hog feeder (100) with the weight activated floor (112) in an elevated first position and the door (142) in a closed position in which the birth control dispensing device (170) and/or toxin dispensing device (180) are each in a non-dispensing position. As further shown in both FIG. 4, the weight activated floor (112) extends internally within the enclosed housing and underneath the openable and closable door (142). As further shown in FIGS. 4 and 11, when the weight activated floor (112) is in an elevated first position (i.e., before the weight threshold has been applied to the weight activated floor), the door stop (144) positioned on the weight activated floor (112) and immediately behind the door (142) prevents the door from rotating/pivoting internally into the enclosed housing, thus maintaining the door in a closed position. As further shown in FIGS. 4 and 11 and as further indicated by the flow path (“FP”) in FIG. 4, when the weight activated floor (112) is in an elevated first position the feed trough (150) and bulk food storage trough (160) are in fluid communication with one another in which partition (118) is not blocking the opening between the feed trough (150) and bulk food storage trough (160) such that food (260) may be metered from the bulk food storage trough (160) into the feed trough while the door (142) is maintained in a closed position.

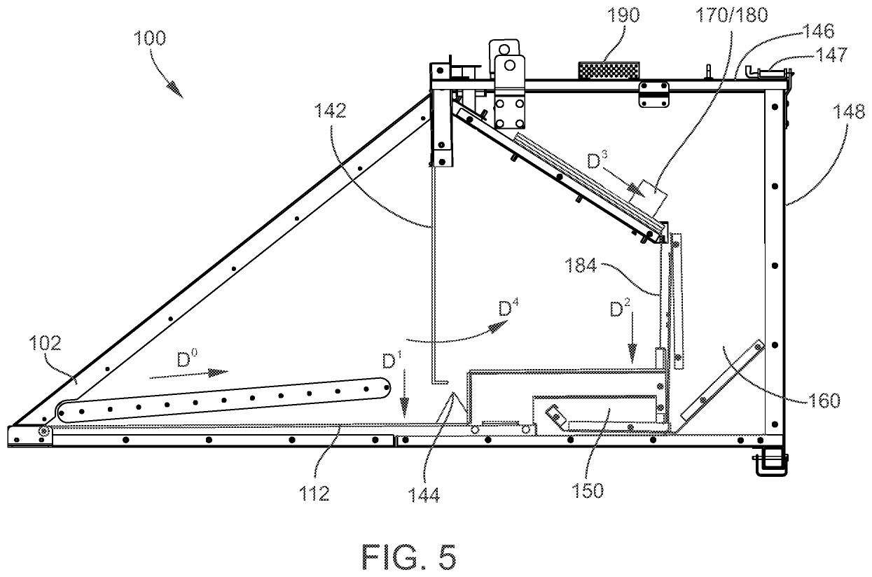

In contrast to FIGS. 4 and 11, FIGS. 5 and 12 depict the feral hog feeder (100) with the weight activated floor (112) in a lowered position as well as the birth control dispensing device (170) and/or toxin dispensing device (180) in a dispensing position. With specific reference to FIG. 5, a feral hog meeting the weight threshold enters the opening (103) of the partially enclosed ramp (102) and advances into the feeder/assembly (100) in direction D⁰ towards the enclosed housing (140). As the non-feral hog continues to advance within the feeder/assembly (100) in direction D⁰ towards the enclosed housing (140), the weight activated floor (112) is deployed and lowers from the elevated first position (shown in FIGS. 4 and 11) to a lowered position (shown in FIGS. 5 and 12); the weight activated floor (112) lowers in direction D¹ towards the bottom wall (110) of the partially enclosed ramp. As further shown in FIGS. 5 and 12, when the weight activated floor (112) is fully deployed and in the lowered position, sufficient clearance exists between the door (142) and door stop (144) such that the feral hog may advance/push the door in direction D⁴ (i.e., an open position) internally within the enclosed housing (140) to enter into the enclosed housing, gain access to the food on the feed trough (150), and consume the same. As further shown in FIGS. 5 and 12, when the weight activated floor (112) is fully deployed and in the lowered position, partition (118) also concurrently moves with the weight activated floor in direction D² (in a direction towards the bottom wall (110) of the partially enclosed ramp (102)) thereby blocking the opening between the feed trough (150) and bulk food storage trough (160) such that only food (260) in the feed trough may be consumed by the feral hog, but the feral hog does not have access to any additional food within the bulk food storage bin (160) nor will any additional food (260) be metered into feed trough (150) until the feral hog exits the feeder/assembly and the weight activated floor returns to the elevated first position (shown in FIGS. 4 and 11). As further shown in FIGS. 5 and 12 (in view of FIGS. 4 and 11), the birth control dispensing device (170) and/or toxin dispensing device (180) are operably connected to weight activated floor (112) and work in concert with one another. In particular and as the weight activated floor (112) moves from an elevated first position (shown in FIGS. 4 and 11) into the lowered position (shown in FIGS. 5 and 12), the birth control dispensing device (170) and/or toxin dispensing device (180) move in direction D³ from a non-dispensing position (shown in FIGS. 4 and 11) into a dispensing position (shown in FIGS. 5 and 12) such that the birth control agent and/or toxin (a predetermined amount) is immediately and freshly dispensed directly onto the food immediately before the feral hog consumes the same. This temporal sequence of events and dispensing (i.e., freshly dispensing a predetermined amount upon each entry into the enclosing housing) from the birth control dispensing device (170) and/or toxin dispensing device (180) advantageously increases efficacy of the birth control agent and/or toxin when ingested by the feral hog by maintaining potency and increasing the lifespan and usability of the birth control agent and/or toxin housed within the birth control dispensing device (170) and/or toxin dispensing device (180). In view of the above and once the feral hog consumes the desired amount of food from the feed trough (150) with the toxin and/or birth control agent dispensed thereon, the feral hog exits the feeder/assembly (100) and the weight activated floor returns to the elevated first position (shown in FIGS. 4 and 11) more food is metered into the feed trough (150) from the bulk food storage trough (160) and the door (142) returns to and is maintained in a closed position until another feral hog meeting the weight threshold enters the feeder/assembly (100).

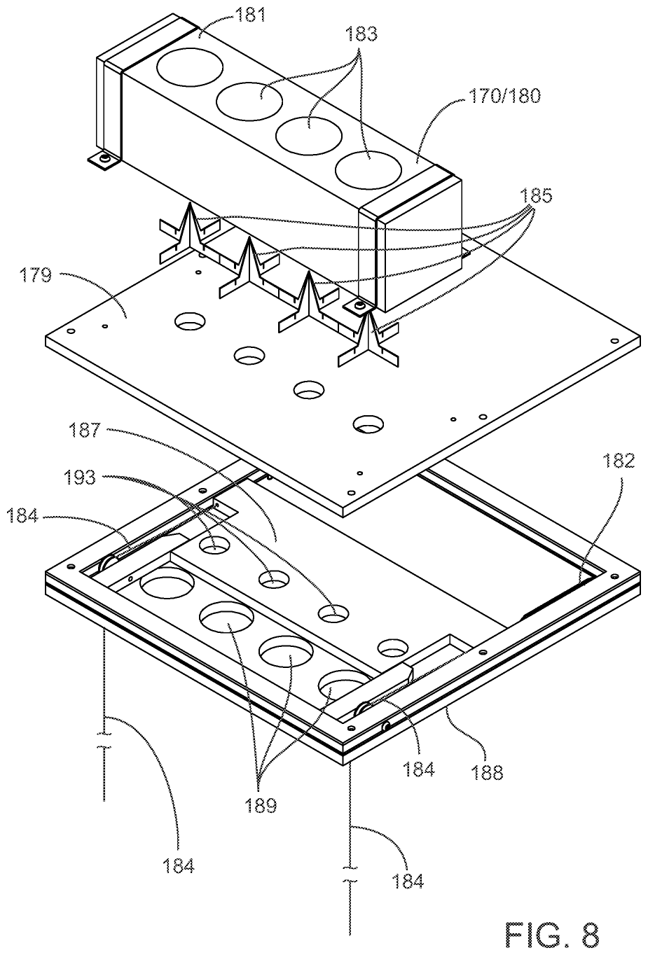

In view of the above, FIGS. 8-10 provide further detail regarding operability of the birth control dispensing device (170) and/or toxin dispensing device (180) as well as the operable connection between weight activated floor (112) and these dispensing devices (170, 180). As shown within FIGS. 8-10, the birth control dispensing device (170) and/or toxin dispensing device (180) includes a stationary receptacle (181) having a first plurality of openings (183) axially aligned with a second plurality of openings (186), the receptacle (181) via openings (183 and 186)) are configured to receive and house a container of toxin (not shown) and/or birth control agent (not shown) within the receptacle (181) as well as dispense the toxin and/or birth control agent therefrom. Within the birth control dispensing device (170) and/or toxin dispensing device (180), there is also movable/actuatable plate (187) positioned between the stationary receptacle (181) and stationary bottom plate (188). In certain aspects and as shown in FIGS. 8-10, the stationary receptacle (181) may be mounted on stationary top plate (179) which is affixed to the stationary bottom plate (188) and having the movable/actuatable plate (187) positioned there between. In any of the configurations mentioned immediately above, the movable/actuatable plate (187) is configured to move (in direction D³ (up and down within the dispensing devices (170, 180) as shown in FIGS. 5, 9, 11, and 12) with a predetermined amount of toxin and/or birth control agent moved from the stationary receptacle (181) to the dispensing through holes (189) on the bottom plate in order to dispense the toxin and/or birth control agent onto the feed (260).

In view of the above, the plurality of through holes (193) positioned in the movable/actuatable plate (187) have a diameter configured to receive and contain a predetermined amount/concentration of toxin and/or birth control agent (e.g., in powder form) from a container housing toxin or birth control agent while in the non-dispensing position and move the same within the plurality of through holes (193) from a non-dispensing position to a dispensing position (as shown in FIG. 12). In particular and as shown in FIGS. 11 and 12 in view of FIGS. 8-10, the movable/actuatable plate (187) is configured to move from a non-dispensing position in which the plurality of through holes (193) of the movable/actuatable plate (187) are initially axially aligned with a corresponding opening in the second plurality of openings (186) in the stationary receptacle (181) to a dispensing position in which the plurality of through holes (193) of the movable/actuatable plate (187) move and are axially aligned with the dispensing through holes (189) in the stationary bottom plate (188) (as shown for example in FIG. 12) to dispense toxin and/or birth control agent directly onto the food in the feed trough (150) positioned below.

The arrangement of cables (184) and biasing member(s) (182) (e.g., springs) shown in FIGS. 8-10 are responsible for maintaining the birth control dispensing device (170) and/or toxin dispensing device (180) in a non-dispensing position as well as the weight activated floor (112) in an elevated first position until the weight threshold is met and the weight activated floor is subsequently moved to a lowered position. In particular, FIGS. 8-10, in view of FIGS. 11 and 12, depict cables (184) having a first end connected to the movable/actuatable plate (187) and a second end connected to end of the weight activated floor (112) having the partition (118) positioned thereon. As further shown in FIGS. 8-10, the birth control dispensing device (170) and/or toxin dispensing device (180) further includes a biasing member(s) (182) (e.g., spring) positioned between and connected to the movable/actuatable plate (187) and stationary bottom plate (188); the biasing member(s) (182) biases and maintains axial alignment of the plurality of through holes (193) of the movable/actuatable plate (187) with the second plurality of openings (186) in the stationary receptacle (181) in a non-dispensing position as well as maintains the weight activated floor (112) in an elevated first position. In view of FIGS. 5 and 12, when a feral hog that meets the desired weight threshold walks on the weight activated floor (112), force is concurrently applied to the weight activated floor (112), cables (184), and biasing member (182) and exerts force in a direction opposite the biasing force exerted by the biasing member thereby deploying the weight activated floor (112) in to a lowered position as well as actuating the movable/actuatable plate (187) such that birth control agent and/or toxin is dispensed onto the food (260).

As further shown in FIGS. 8-10, in certain aspects container opening devices (185) may be affixed within the stationary receptacle (181) and are configured to open containers of the toxin and/or birth control agent when place therein. As further shown in FIGS. 8-10, in certain aspects these container opening devices (185) may be pointed protrusions and/or blades configured to pierce the above mentioned containers. In certain aspects, the birth control agent may be in liquid form. In this instance, the container having the birth control agent therein may be a bottle equipped with an elastomeric nipple. This nipple may be positioned within each of the openings (186, 193, and 189) and may include a nipple end aligned over the feed trough (150) (and/or the food placed thereon) and the nipple may be pinched in a non-dispensing position such that the birth control agent in liquid form is not dispensed. In this instance and when the weight activated floor is lowered, the movable/actuatable plate (187) moves such that the nipple is no longer pinched and the birth control agent in liquid form may be dispensed therefrom. When the weight activated floor returns to the elevated first position, the elastomeric nipple is again pinched and the birth control agent in liquid form can no longer be dispensed therefrom.

In certain aspects, the toxin disclosed herein is sodium nitrite (e.g., in powder form) dispensed in a predetermined amount to be lethal amount to a feral hog weighing 70 lbs., 100 lbs., 125 lbs., 150 lbs., 175 lbs., 200 lbs., or greater than 200 lbs. The toxin may further be concurrently dispensed with a masking agent to further ensure consumption of the toxin by the feral hog. In certain additional aspects, the birth control agent includes an effective amount of cotton seed oil and/or gossypol. It is envisioned that the feeders/assemblies (100) disclosed herein may dispense any combination of toxin, masking agent, and birth control agent concurrently.

The exterior components of the feeders/assemblies (100) are metal and are preferably a galvannealed metal having a uniform matte grey color with low reflectivity that can be easily painted if desired. This material is preferably strong, durable, and has very low oxidation in order to resist rust formation. Likewise, the interior components of the feeders/assemblies (100) within the enclosed housing are preferably formed or a strong, durable, metal material that further resists rust formation. In certain aspects, the interior components are also formed of a galvannealed metal.

As further shown in FIGS. 1 and 2, stabilization bars (196) may be further affixed to the feeders/assembly (100) to stabilize and reduce and/or prevent the assembly from flipping over when assembled and/or in use. These stabilization bars are further formed of a strong, durable, metal material that further resists rust formation, which in certain instances includes galvannealed metal.

Also disclosed herein are dolleys and/or trailers having sufficient size to load the feeders/assemblies (100) thereon to easily transport the feeders/assemblies (100) to and from different locations.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A feral hog feeder assembly comprising:
(a) a partially enclosed entrance ramp configured for entry of feral hogs therein while concurrently deterring entry of non-porcine animals;
(b) an enclosed housing directly attached to one end of the partially enclosed entrance ramp, the enclosed housing having an openable and closable door positioned adjacent to the one end of the partially enclosed entrance ramp and a food dispensing device as well as a birth control dispensing device and/or toxin dispensing device housed within the enclosed housing, the food dispensing device as well as the birth control dispensing device and/or toxin dispensing device are configured to dispense predetermined amounts of food, birth control agents, toxin or combinations thereof; and
(c) a global positioning system (GPS) unit operably coupled to the door, the GPS unit is configured to monitor frequency of use of the assembly by feral hogs by tracking and transmitting frequency of door openings and closings to a peripheral device of a user.

2. The feral hog feeder assembly of claim 1, wherein the GPS unit is further configured to track amounts of food remaining in the feeder assembly, amounts of birth control agents remaining in the birth control dispensing device, amounts of toxin remaining in the toxin dispensing device, or any combination thereof based on the frequency of door openings and closings and transmit the same to the peripheral device of the user.

3. The feral hog feeder assembly of claim 1, wherein the partially enclosed ramp comprises:
(i) an opening on one end of the partially enclosed ramp that is spaced apart from and opposite to the end directly attached to the enclosed housing;
(ii) two spaced apart sidewalls spanning an entire length between the opening of the partially enclosed ramp and the end directly attached to the enclosed housing, the two spaced apart sidewalls configured to maintain the feral hogs therein; and
(iii) a bottom wall positioned between and directly connected to the two spaced apart sidewalls.

4. The feral hog feeder assembly of claim 3, wherein the partially enclosed ramp further comprises a weight activated floor attached thereto that is spaced apart and positioned above the bottom wall of the partially enclosed ramp, the weight activated floor is configured to move from an elevated first position in a direction towards the bottom wall when a predetermined weight threshold is applied thereon to allow for opening of the door.

5. The feral hog feeder assembly of claim 4, wherein the weight activated floor extends internally within the enclosed housing and underneath the openable and closable door, the weight activated floor including a door stop positioned thereon that prevents opening of the door internally into the enclosed housing until the predetermined weight threshold is applied on the weight activated floor and the weight activated floor is moved in a direction towards the bottom wall of the partially enclosed ramp.

6. The feral hog feeder assembly of claim 5, wherein the food dispensing device comprises a feed trough and a bulk food storage trough that are in fluid communication with one another when the weight activated floor is in the elevated position first position and the feed trough and bulk food storage trough are selectively separated from one another by a partition positioned on an end of the weight activated floor as the weight activated floor is moved in a direction towards the bottom wall of the partially enclosed ramp.

7. The feral hog assembly of claim 6, wherein the birth control dispensing device and/or toxin dispensing device is positioned above the feed trough and configured to dispense the birth control agent and/or toxin into the feed trough as the weight activated floor is moved in a direction towards the bottom wall of the partially enclosed ramp.

8. The feral hog assembly of claim 7, wherein the weight activated floor and birth control dispensing device and/or toxin dispensing device are operably connected to one another and move in concert with one another.

9. The feral hog assembly of claim 8, further comprising a biasing member operably connected to the partition positioned on the end of the weight activated floor and the birth control dispensing device and/or toxin dispensing device, the biasing member configured:
(i) to bias the birth control dispensing device and/or toxin dispensing device in a closed, non-dispensing position while the weight activated floor is in the elevated first position; and
(ii) to selectively move the birth control dispensing device and/or toxin dispensing device into an open, dispensing position when the weight activated floor is actuated in a direction towards the bottom wall of the partially enclosed ramp such that birth control agents and/or toxin is dispensed from the respective birth control dispensing and/or toxin dispensing devices when the partition positioned on the end of the weight activated floor separates the feed trough from the bulk food storage trough.

10. The feral hog assembly of claim 9, wherein the birth control dispensing device and/or toxin dispensing device comprises a plurality of plates in which:
a first plate and/or receptacle is fixed in place and is configured to receive an opened container of birth control agents, toxins or a combination thereof thereon;
(ii) an actuatable plate positioned immediately underneath the first plate that is operably connected to the biasing member, the actuatable plate is configured to move:
(1) from a closed position in which the actuatable plate includes an opening configured to align with an opening formed in the first plate to receive a predetermined amount of birth control agents, toxins, and/or a combination thereof therein
(2) to an open position in which the actuatable plate moves toward an opening positioned immediately beneath the actuatable plate such that the opening in the actuatable plate having the predetermined amount of birth control agents, toxins, and/or a combination thereof therein aligns with openings positioned immediately beneath the actuatable plate to dispense the birth control agents, toxins or a combination thereof from the actuatable plate into the feed trough.

11. The feral hog feeder assembly of claim 10, further comprising a plurality of spaced apart bars securely positioned above the weight activated floor that are configured to deter non-ungulate animals from entering the partially enclosed ramp, each bar having a longitudinal axis that is perpendicular relative to a longitudinal axis of the partially enclosed ramp.

12. The feral hog feeder assembly of claim 11, wherein each bar is rotatable about its longitudinal axis.

13. The feral hog feeder assembly of claim 12, further comprising stabilization bars affixed to the assembly that are configured to stabilize and reduce and/or prevent the assembly from flipping over when assembled.

14. The feral hog feeder assembly of claim 13, wherein a first stabilization bar is affixed to a bottom surface of the partially enclosed entrance ramp and extends in a direction away from an outermost surface of each of the two spaced apart sidewalls, and a second stabilization bar is affixed to a bottom surface of the enclosed housing and extends in a direction from outermost surfaces of the enclosed housing, with the first and second stabilization bars being arranged parallel to one another.

15. The feral hog feeder assembly of claim 14, wherein the toxin comprises a lethal amount of sodium nitrite and optionally a masking agent and the birth control agent comprises an effective amount of cotton seed oil and/or gossypol.

16. A feral hog feeder comprising:
(a) a partially enclosed entrance ramp configured for entry of feral hogs therein while concurrently deterring entry of non-porcine animals;
(b) an enclosed housing directly attached to one end of the partially enclosed entrance ramp, the enclosed housing having an openable and closable door positioned adjacent to the one end of the partially enclosed entrance ramp and a food dispensing device as well as a birth control dispensing device and/or toxin dispensing device housed within the enclosed housing, the food dispensing device as well as the birth control dispensing device and/or toxin dispensing device are configured to dispense predetermined amounts of food, birth control agents, toxin or combinations thereof; and
(c) a global positioning system (GPS) unit operably coupled to the door, the GPS unit is configured to monitor frequency of use of the feeder by feral hogs by tracking and transmitting frequency of door openings and closings to a peripheral device of a user.

17. The feral hog feeder of claim 16, wherein the GPS unit is further configured to track amounts of food remaining in the feeder, amounts of birth control agents remaining in the birth control dispensing device, amounts of toxin remaining in the toxin dispensing device, or any combination thereof based on the frequency of door openings and closings and transmit the same to the peripheral device of the user.

18. The feral hog feeder of claim 16, wherein the partially enclosed ramp comprises:
an opening on one end of the partially enclosed ramp that is spaced apart from and opposite to the end directly attached to the enclosed housing;
(ii) two spaced apart sidewalls spanning an entire length of the ramp between the opening of the partially enclosed ramp and the end directly attached to the enclosed housing, the two spaced apart sidewalls configured to maintain the feral hogs therein; and
(iii) a bottom wall positioned between and directly connected to the two spaced apart sidewalls.

19. The feral hog feeder of claim 18, wherein the partially enclosed ramp further comprises a weight activated floor attached thereto that is spaced apart from and positioned above the bottom wall of the partially enclosed ramp, the weight activated floor is configured to move from an elevated first position in a direction towards the bottom wall when a predetermined weight threshold is applied thereon to allow for opening of the door.

20. The feral hog feeder of claim 19, wherein the weight activated floor extends internally within the enclosed housing and underneath the openable and closable door, the weight activated floor including a door stop positioned thereon that prevents opening of the door internally into the enclosed housing until the predetermined weight threshold is applied on the weight activated floor and the weight activated floor is moved in a direction towards the bottom wall of the partially enclosed ramp.

21. The feral hog feeder of claim 19, wherein the food dispensing device comprises a feed trough and a bulk food storage trough that are in fluid communication with one another when the weight activated floor is in the elevated position first position and the feed trough and bulk food storage trough are selectively separated from one another by a partition positioned on an end of the weight activated floor as the weight activated floor is moved in a direction towards the bottom wall of the partially enclosed ramp.

22. The feral hog feeder of claim 21, wherein the birth control dispensing device and/or toxin dispensing device is positioned above the feed trough and configured to dispense the birth control agent and/or toxin into the feed trough as the weight activated floor is moved in a direction towards the bottom wall of the partially enclosed ramp.

23. The feral hog feeder of claim 22, wherein the weight activated floor and birth control dispensing device and/or toxin dispensing device are operably connected to one another and move in concert with one another.

24. The feral hog feeder of claim 23, further comprising a biasing member operably connected to the partition positioned on the end of the weight activated floor and the birth control dispensing device and/or toxin dispensing device, the biasing member configured:
(i) to bias the birth control dispensing device and/or toxin dispensing device in a closed, non-dispensing position while the weight activated floor is in the elevated first position; and
(ii) to selectively move the birth control dispensing device and/or toxin dispensing device into an open, dispensing position when the weight activated floor is actuated in a direction towards the bottom wall of the partially enclosed ramp such that birth control agents and/or toxin is dispensed from the respective birth control dispensing and/or toxin dispensing devices when the partition positioned on the end of the weight activated floor separates the feed trough from the bulk food storage trough.

25. The feral hog feeder of claim 24, wherein the birth control dispensing device and/or toxin dispensing device comprises a plurality of plates in which:
a first plate is fixed in place and is configured to receive an opened container of birth control agents, toxins or a combination thereof thereon;
(ii) an actuatable plate positioned immediately underneath the first plate that is operably connected to the biasing member, the actuatable plate is configured to move:
(1) from a closed position in which the actuatable plate includes an opening configured to align with an opening formed in the first plate to receive a predetermined amount of birth control agents, toxins, and/or a combination thereof therein
(2) to an open position in which the actuatable plate moves toward an opening positioned immediately beneath the actuatable plate such that the opening in the actuatable plate having the predetermined amount of birth control agents, toxins, and/or a combination thereof therein aligns with openings positioned immediately beneath the actuatable plate to dispense the birth control agents, toxins or a combination thereof from the actuatable plate into the feed trough.

26. The feral hog feeder of claim 25, further comprising a plurality of spaced apart bars securely positioned above the weight activated floor that are configured to deter non-ungulate animals from entering the partially enclosed ramp, each bar having a longitudinal axis that is perpendicular relative to a longitudinal axis of the partially enclosed ramp.

27. The feral hog feeder of claim 26, wherein each bar is rotatable about its longitudinal axis.

28. The feral hog feeder of claim 27, further comprising stabilization bars affixed to the feeder that are configured to stabilize and reduce and/or prevent the feeder from flipping over when in use.

29. The feral hog feeder of claim 28, wherein a first stabilization bar is affixed to a bottom surface of the partially enclosed entrance ramp and extends in a direction away from an outermost surface of each of the two spaced apart sidewalls, and a second stabilization bar is affixed to a bottom surface of the enclosed housing and extends in a direction from outermost surfaces of the enclosed housing, with the first and second stabilization bars being arranged parallel to one another.

30. The feral hog feeder of claim 29, wherein the toxin comprises a lethal amount of sodium nitrite and optionally a masking agent and the birth control agent comprises an effective amount of cotton seed oil and/or gossypol.
